(19) United States
(12) Patent Application Publication
(10) Pub. No.: US 2010/0119872 A1
(43) Pub. Date: May 13, 2010

(54) IRON-BASED HARD FACING ALLOYS WITH RARE EARTH ADDITIONS

(76) Inventors: Calvin D. Lundeen, Lynchburg, VA (US); Tony A. Grant, North Richland Hills, TX (US)

Correspondence Address: PIETRAGALLO GORDON ALFANO BOSICK & RASPANTI LLP, ONE OXFORD CENTRE, 38TH FLOOR, 301 GRANT STREET, PITTSBURGH, PA, 15219-6404, US

(21) Appl. No.: 12/618,227

(22) Filed: Nov. 13, 2009

Related U.S. Application Data
(60) Provisional application No. 61/114,186, filed on Nov. 13, 2008.

(51) Int. Cl. B32B 15/01; C22C 37/08

(52) U.S. Cl. 428/682; 420/14

(57) ABSTRACT

A liner material for a backing steel cylinder, comprising an iron-based hard facing alloy comprising at least one rare earth element, and a high pressure cylinder assembly, comprising a backing steel cylinder, and a liner covering at least a portion of an inner surface of the backing steel cylinder, the liner comprising an iron-based hard facing alloy comprising at least a rare earth element are disclosed. The thickness of the liner material in the cylinder ranges from 0.030 inches (762 microns) to 0.375 inches (9525 microns). A method of lining a high pressure cylinder assembly, comprising applying an iron-based hard facing alloy comprising at least one rare earth element onto the backing steel cylinder of the high pressure cylinder assembly is also disclosed. The rare earth element includes cerium in an amount less than 2 weight percent based on the weight of the iron-based hard facing alloy.

### CROSS REFERENCE TO RELATED APPLICATION

This application claims priority to U.S. Provisional Application Ser. No. 61/114,186 filed Nov. 13, 2008, which is incorporated herein by reference.

### FIELD OF THE INVENTION

This invention relates to hard facing materials, and more particularly to iron-based hard facing alloys containing rare earth additions that are useful for various applications including abrasion resistant coatings and/or linings for bi-metallic plasticating cylinders and plasma coatings for various substrates.

### BACKGROUND INFORMATION

The current state of the art in making bi-metallic plasticating cylinders for use in plastics extruders, blow molding, or injection molding machinery requires the manufacturer to cast and hot isostatically press or shrink fit a liner or inlay into a larger tube known as a backing material or backing tube. Centrifugal casting can create an inseparable bond between the high-strength back material, e.g. steel and the wear resistant alloy liner. In a bi-metallic barrel construction, the liner or inlay provides a protective wear surface which is fused to the high strength backing material. An example of a high pressure bi-metallic cylinder is described in U.S. Pat. No. 6,887,322, which is incorporated herein by reference and which discloses a heat treatment process for a liner assembly.

Although other methods are possible, for economic reasons, iron-based hard facing alloys are typically cast into a larger tube and applied to the interior surface of such bi-metallic cylinders. In the most common method, an alloy or aggregate (castable) is placed into the tube. The ends of the tube are then “capped” with at least one vented end. The cylinder is then heated on rollers until the castable melts. In many applications, the cylinder is heated above 2000° F. The vented end prevents the pressure in the cylinder from getting too high. Once the alloy is molten, the cylinder is removed from the furnace and rotated at high speeds as it cools. The effect is to deposit the castable onto the interior of the tube. This deposit is known as a liner or inlay.

The purpose of the liner or inlay is to impart wear and corrosion resistance to the cylinder to increase the life of the plasticating cylinder versus alternatives that might be manufactured from a single piece of material. Common cast liners are alloys of iron or nickel with other transition elements alloys with additions of chrome, boron and silicon. Elements such as phosphorus and sulphur may be present in small quantities. An example of a common cast liner is the iron-based hard facing alloys discussed herein above.

For general wear resistance, materials using the bi-metallic applications tend to be very hard. Rockwell hardness values of these materials typically range from 50 to 75 HRC. Hardness is not the only factor that influences wear behavior, and these materials, particularly the traditional iron-based hard facing materials, have exhibited lower abrasive resistance and lower durability because of limited toughness.

With regard to the traditional iron-based hard facing alloy materials used in bi-metallic applications, conventional methods of improving the durability and wear resistance of such a liner generally require a complete change in chemistry or hardness of the liner to the extent that the liner is dissimilar to or incompatible with the material of the mating components such as the cylinder and screw of an extruder. This approach for improving the durability and wear resistance of a centrifugally cast liner may be problematic for general purpose materials, because a change in chemistry or hardness of the liner that works well for one screw material may result in other screw materials being incompatible with the liner such that it may be necessary to change the material of the screw and/or cylinder of the extruder.

There is a need therefore to increase the durability and wear resistance of an iron-based hard facing alloy liner without adding elements to the alloy chemistry that would increase the liner hardness while maintaining or increasing the compatibility of the liner with the wear surfaces of the mating components.

There is a further need to increase the durability and abrasion resistance of iron-based hard facing alloy materials and other materials used as a liner in plasticating equipment without significantly altering the hardness of the material or the compatibility between the screw and liner materials without adversely affecting the performance of these components.

### SUMMARY OF THE INVENTION

An aspect of the invention is to provide a liner material for a backing steel cylinder, comprising an iron-based hard facing alloy comprising at least one rare earth element, such as cerium in an amount less than 2 weight percent based on the total weight of the iron-based hard facing alloy.

Another aspect of the invention is to provide a high pressure cylinder assembly, comprising a backing steel cylinder and a liner covering at least a portion of an inner surface of the backing steel cylinder comprising an iron-based hard facing alloy comprising at least one rare earth element, such as cerium in an amount less than 2 weight percent based on the total weight of the iron-based hard facing alloy.

A further aspect of the present invention is to provide a method of lining a high pressure cylinder assembly, comprising applying an iron-based hard facing alloy comprising at least one rare earth element onto the backing steel cylinder of the high pressure cylinder assembly, such as cerium in an amount less than 2 weight percent based on the total weight of the iron-based hard facing alloy.

These and other aspects of the present invention will be more apparent from the following description.

### BRIEF DESCRIPTION OF THE DRAWINGS

FIG. 1 is a graph of mass loss (mg) for a conventional iron-based hard facing alloy materials (Samples A and B) and an iron-based hard facing alloy material of the present invention containing cerium (Sample C) demonstrating highly improved abrasion resistance of the latter when subjected to a dry sand abrasive test (ASTM G65).

FIG. 2 is a graph of mass loss (mg) versus time for the conventional iron-based hard facing alloy materials (Samples A and B) and the iron-based hard facing alloy material of the present invention containing cerium (Sample C) demonstrating highly improved abrasion resistance of the latter when subjected to a slung abrasion test (ASTM G75).

### DETAILED DESCRIPTION

The present invention provides iron-based hard facing alloy materials containing rare earth element additions. Rare earth elements are in the lanthanide series of the Periodic Table, and include scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu). In one embodiment of the invention, the rare earth alloying addition is Ce.

In an embodiment of the invention, the rare earth element may be added to conventional chemistries for iron-based hard facing alloy materials, typically in amounts of less than 2 weight percent. In some instances, these rare earth elements may be added in smaller amounts ranging from 0.01 to 0.5 weight percent based on the total weight of the final composition of the iron-based hard facing alloy. In other instances, these rare earth elements may be added in amounts ranging from 0.05 to 0.2 weight percent based on the total weight of the final iron-based hard facing alloy. This narrow range would be used to maximize uniformity in the material. Care should be taken to avoid changing the basic constituents of the hard facing composition to the extent that slight alterations in other elements of the alloy material may be required. These slight modifications would only be necessary to ensure that the hardness of the iron-based hard facing alloy material will not be changed.

In addition to iron and rare earth alloying additions, the hard facing materials of the present invention may include one or more elements selected from chromium (Cr), boron (B), silicon (Si), carbon (C), phosphorus (P), sulphur (S), nickel (Ni), manganese (Mn), molybdenum (Mo), iron (Fe), cobalt (Co), tungsten (W), titanium (Ti) and vanadium (V).

The iron-based hard facing alloy materials of the present invention may be used as a liner or inlay in a high pressure bi-metallic cylinder as described in the aforesaid U.S. Pat. No. 6,887,322. In an embodiment of the invention, the liner is a centrifugally cast liner being applied to the interior of the cylinder as opposed to being applied by spraying or dipping. In some embodiments of the invention, the composition of the iron-based hard facing alloy material comprising a centrifugally cast liner in a high pressure bi-metallic cylinder comprises cerium as the rare earth addition. In this embodiment, the chemistry of a conventional iron-based hard facing alloy material may be modified with additions of cerium (Ce) as shown in Tables 1 and 2 below:

TABLE 1
Composition of Conventional Iron-Based Hard Facing Alloy Material

| | Min | Max |
|---|---|---|
| Chromium | 0.80 | 1.10 |
| Boron | 0.95 | 1.20 |
| Silicon | 0.80 | 1.10 |
| Carbon | 3.20 | 3.50 |
| Phosphorus | 0.00 | 0.02 |
| Sulfur | 0.00 | 0.02 |
| Nickel | 3.60 | 4.15 |
| Manganese | 1.45 | 1.75 |
| Iron | Balance | |

TABLE 2
Composition of Iron-Based Hard Facing Alloy Material With
Cerium Additions

| | Min | Max |
|---|---|---|
| Chromium | 0.90 | 1.20 |
| Boron | 1.00 | 1.25 |
| Silicon | 0.80 | 1.10 |
| Carbon | 3.20 | 3.50 |
| Phosphorus | 0.00 | 0.025 |
| Sulfur | 0.00 | 0.020 |
| Nickel | 3.70 | 4.25 |
| Manganese | 1.30 | 1.60 |
| Cerium | 0.05 | 0.20 |
| Iron | Balance | |

Once in solution, cerium has a beneficial effect of reacting with other elements, such as sulfur. Metallurgists have been known to avoid using cerium when centrifugally casting a product, especially when the alloy content is low, because cerium tends to be highly reactive. To avoid significant burn off and the incorporation of oxides in the melt in centrifugally casting, the hard facing material should be loaded in ingot or rod form to reduce the exposed surface area of the metal. In one embodiment, an excess of Ce is provided in order to compensate for losses during production of the ingot or rod. For example, when using cerium in the iron-based hard facing alloy, in order to have a liner that contains about 0.05% weight percent cerium, it may be necessary for the foundary to add about 2.5% weight percent cerium to the hard facing composition when the ingots are cast.

In some embodiments of the invention, the thickness of the liner in the cylinder may range from about 0.03 inch (762 microns) to about 0.375 inch (9525 microns).

The iron-based hard facing alloy material of the present invention and the iron-based hard facing alloys commercially available may be applied to the interior wear surface of a bi-metallic cylinder as a liner or an inlay using a centrifugally casting procedure similar to the following:

1. Inspect the materials. The steel bar stock should be straight within ⅛ inch (0.32 cm) over 60 inches (152 cm). The steel bar stock will be a solid bar or tube with a straight and constant outside diameter (OD). The steel bar stock should be in the annealed or normalized condition. If not, the centrifugal casting process will occur at a temperature that will anneal the material.

2. Bore a hole in the steel bar so that the hole is larger than the desired finished size of the cylinder, by twice the desired thickness of the inlay thickness of the hard facing material. That is, if the desired inlay thickness is 0.03 inch and the finished bore size is 2 inches, then the hole that is to be bored into the steel tube will be 2.06 inches.

3. This bar becomes the cylinder, but needs additional stock to survive the furnace heat cycle. Turn the OD of the steel bar so that the OD is concentric with the inner diameter (ID) of the steel bar and at least ⅜ inch larger than the finished OD of the cylinder.

4. Load a volume of castable iron-based hard facing alloy into the ID of the cylinder so that after casting, the ID of the cylinder will be smaller than the finished size of the cylinder. Typically the cast ID is smaller than the finished ID by the thickness of the inlay so that any casting defects can be removed during further processing of the cylinder.

5. Prepare the cylinder for casting by covering the ends with steel end caps and tack welding them in place. At least one cap must be vented so that gas is not trapped in the cylinder.

6. Place the capped cylinder assembly, which comprises the cylinder, caps, and the castable iron-based hard facing alloy, into a furnace that is maintained at 2270° F. (1243° C.). Rotate the cylinder slowly in the furnace. As long as the hard facing alloy is not fully melted, the outside temperature of the cylinder will be limited by the melting point of the iron-based hard facing alloy.

7. Pull or push the cylinder assembly from the furnace when the outside temperature of the cylinder reaches 2250° F. (1232° C.).

8. Cool the cylinder on spinner rolls at high rpm so that the interior bore of the cylinder experiences 20 or more gravities of acceleration. As the cylinder cools, the hard facing material will solidify as a thin layer or inlay on the bore of the cylinder.

9. When the temperature of the cylinder is more than 200° F. (93° C.) less than the alloy's melting temperature, the cylinder can be removed from the spinner rolls and cooled slowly on rolls to ensure that the barrel maintains straightness.

10. Machine the caps from the cylinder to remove the caps.

11. Hone excess material from the bore so that the hard facing material can be inspected for casting related defects.

12. If the cylinder is free from casting related defects, finish the barrel as required.

This process for the centrifugal casting of iron-based hard facing materials can be varied considerably and still be successful. The furnace temperature listed in step 6 could be varied by more than 1000° F. (538° C.) thereby affecting the time required for processing and to a lesser extent, the temperature in which the cylinder is removed from the furnace. The temperature at which the cylinder is removed from the furnace can also be varied by several hundred degrees depending on the geometry of the cylinder and the precise melting point of the alloy. Lastly, while the cylinder may be removed from the spinner rolls once the hard facing material has solidified, the cylinder could be cooled further as part of a heat treatment procedure. This cool down procedure may impart a significant improvement of material properties to the cylinder, in addition to those achieved by the present invention.

In view of the above process, the hard facing alloy of the present invention covers at least a portion of an inner surface of the backing steel cylinder.

The invention is further described in the following Example. This Example is intended to illustrate various aspect of the present invention, and is not intended to limit the scope of the invention.

### Example

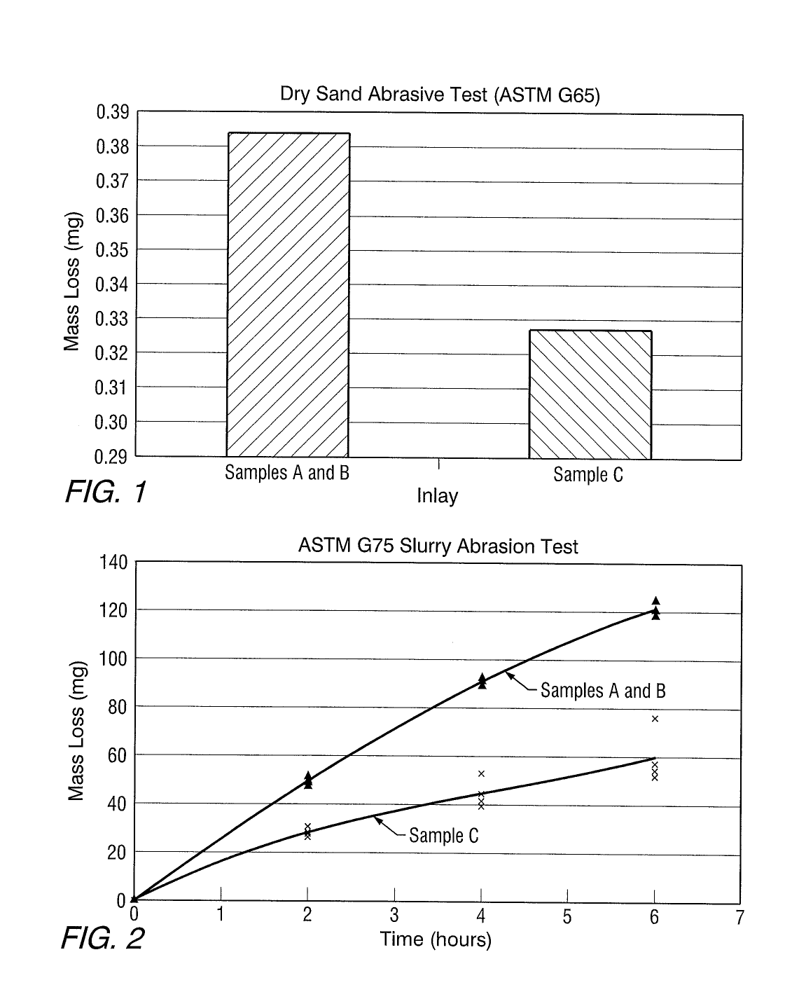

Test ring samples were cut from three cylinders, two from the original hard facing materials designated as Samples A and B and one from the hard facing material of the invention (inventive material) designated as Sample C in the tables below and in the graphs of FIGS. 1 and 2. Samples A, B, and C were produced as centrifugally cast liners similar to the procedure outlined in the above steps 1 through 12.

The chemical composition of each of the three samples is shown in Table 3 below.

TABLE 3

| | Sample | | |
|---|---|---|---|
| | A | B | C |
| Chromium | 0.930 | 1.040 | 1.125 |
| Boron | 1.040 | 0.980 | 1.200 |
| Silicon | 0.981 | 1.000 | 0.980 |
| Carbon | 3.350 | 3.250 | 3.400 |
| Phosphorus | 0.013 | 0.008 | 0.014 |
| Sulfur | 0.005 | 0.009 | 0.005 |
| Nickel | 3.720 | 3.690 | 3.820 |
| Manganese | 1.620 | 1.680 | 1.575 |
| Cerium | | | 0.150 |
| Iron | Balance | Balance | Balance |

The composition of the hard facing material of Sample C contained cerium in addition to the other elements which were present in Samples A and B. Since Samples A and B were currently in use, a significant amount of in-process testing data was available, and therefore, the hardness of these Samples A and B were compared with in-process measurements of hardness variability in order to access variations in wear results. Sample A had hardness near the minimum acceptable for an original alloy and Sample B had hardness typical for the original alloy. The inventive material Sample C had hardness less than Sample B but greater than Sample A. For improvements to exist, the wear results for Sample C must show a difference greater than the variation between Sample A and Sample B. If the wear results for Sample C (in all tests) were within variations shown in the original material then there was no significant improvement. If the wear results of the inventive material of Sample C were significantly better than either Sample A or Sample B, then one can be assured that this difference would be significant because Sample A and Sample B expressed a hardness variation expected from the original material.

The original material was centrifugally cast using the procedure of casting a liner with a steel backing for use as a high pressure cylinder as outlined in the above steps 1 through 12, which procedure was also used to obtain Samples A and B. In more than 1000 castings of the original material, the hardness of the material typically fell within a narrow range. While the minimum acceptable hardness was 60 HRC, the average hardness was 63.7 HRC with a lower control limit of 62.3 HRC and an upper control limit of 65 HRC. The expected standard deviation of hardness for the original material was 0.5 HRC. Sample A with an average hardness of 64 HRC was selected to represent the average and Sample B with an average hardness of 60.3 HRC was selected to represent the maximum acceptable deviation from the average (more than six standard deviations in hardness from the average). Sample C (inventive material) had a hardness of 62.6 HRC which is within the normal control limits of the original material.

From the test ring samples of Samples A, B, and C several test samples were cut using wire electronic discharge machining (EDM) which does not mechanically alter the material. This was done in order to avoid affecting the properties of the test ring samples. The test samples of Samples A, B, and C were prepared for the following wear tests: ASTM G77 (Adhesion/Sliding Wear); ASTM G65 (Abrasive Wear); and ASTM G75 (Abrasion Slurry Test). Three or four samples were randomly selected from the test samples of Samples A, B, and C for these wear tests. The wear testing was performed by the Falex Corporation, 1020 Air Park Drive, Sugar Grove, Ill. 60554.

The ASTM G77 wear test is generally correlated with hardness. Since the hardness was held constant (within normal process variation) for each test sample of Samples A, B and C, i.e. 60.3 HRC for Sample A, 64 HRC for Sample B, and 62.6 HRC for Sample C, it was expected that the results would show little change from one test sample to the next. Four test samples indicated in Table 4 as (1), (2), (3) and (4) were used for each Sample A, B and C.

As shown in Table 4, there was no significant difference in wear as represented by the total mass loss (mg) between each of the test samples (1), (2), (3) and (4) of each Sample A, B and C. That is, the average total mass loss of Sample A was 0.0022 mg and the average total mass loss of Sample B was 0.0009 mg compared to the average total mass loss of Sample C which was 0.0013 mg. However, there was a significant and unexpected difference between the average coefficient of friction of Samples A and B compared to that of Sample C. That is, the average coefficient of friction for Samples A and B was 0.362 and 0.360, respectively; whereas the average coefficient of friction for Sample C was 0.120. As discussed herein below, a lower coefficient of friction is often associated with better field performance.

TABLE 4
Results of the ASTM G77 Wear Test for Samples A, B and C

| | | | | Average |
|---|---|---|---|---|
| | | | Total Mass | Coefficient of |
| Material | Products | Hardness | Loss (mg) | Friction (COF) |
| Sample A (1) | Prior Art | 60.3 | 0.0018 | 0.362 |
| Sample A (2) | Prior Art | 60.3 | 0.0040 | 0.365 |
| Sample A (3) | Prior Art | 60.3 | 0.0018 | 0.352 |
| Sample A (4) | Prior Art | 60.3 | 0.0012 | 0.370 |
| Average | | | 0.0022 | 0.362 |
| Sample B (1) | Prior Art | 64 | 0.0005 | 0.357 |
| Sample B (2) | Prior Art | 64 | 0.0017 | 0.356 |
| Sample B (3) | Prior Art | 64 | 0.0003 | 0.363 |
| Sample B (4) | Prior Art | 64 | 0.0009 | 0.363 |
| Average | | | 0.0009 | 0.360 |
| Sample C (1) | Invention | 62.6 | 0.0010 | 0.120 |
| Sample C (2) | Invention | 62.6 | 0.0015 | 0.119 |
| Sample C (3) | Invention | 62.6 | 0.0017 | 0.126 |
| Sample C (4) | Invention | 62.6 | 0.0009 | 0.116 |
| Average | | | 0.0013 | 0.120 |

The wear results in Table 4 indicate that the inventive material (Sample C) would perform as well as the conventional materials (Samples A and B) in general applications and because of the significantly lower coefficient of friction of Sample C, it was expected by the inventors that in some applications, Sample C would perform even better than Samples A and B.

The hardness of the inventive material was within the specifications of the conventional materials. Since the hardness was unchanged, the more generic wear test ASTM G77 showed no consistent change. However, the coefficient of friction of the inventive material of Sample C was less than that of the conventional materials of Samples A and B. This lower coefficient of friction is expected to improve durability of the inventive material in more abrasive applications. By having a lower coefficient of friction, less wear energy is experienced due to friction. Therefore, a lower coefficient of friction can generally be associated with better performance in the field than that indicated by standard testing.

The ASTM G65 Procedure A wear test, which measures abrasion using dry sand and a rubber wheel, was used to indicate wear resistance to abrasion. Three test samples (1), (2), and (3) from each of Samples A, B and C, which were different from the test samples (1), (2), (3) and (4) used for the ASTM G77 wear test, were used in this wear test. The mass loss (mg) of each test sample (1), (2) and (3) was measured after being exposed to a 30 pound load for 6000 cycles with a sand flow rate of 300 to 400 g/min. The test results in Table 5 show a percent change of −15% in mass loss during the test. This is a 15% reduction in wear due to abrasion for the inventive material of Sample C compared to the conventional materials of Samples A and B (prior art). This 15% was calculated by dividing the overall average total mass loss of Samples A and B which is 0.3839 by the average mass loss of Sample A which is 0.3271.

TABLE 5
Results of the ASTM G65 Wear Test for Samples A, B and C

| | | | Total Mass |
|---|---|---|---|
| Material | Products | Hardness | Loss (mg) |
| Sample A (1) | Prior Art | 60.3 | 0.3790 |
| Sample A (2) | Prior Art | 60.3 | 0.3612 |
| Sample A (3) | Prior Art | 60.3 | 0.3588 |
| Average | | | 0.3663 |
| Sample B (1) | Prior Art | 64 | 0.3155 |
| Sample B (2) | Prior Art | 64 | 0.4314 |
| Sample B (3) | Prior Art | 64 | 0.4577 |
| Average | | | 0.4015 |
| Overall Average of | | | 0.3839 |
| Samples A and B | | | |
| Sample C (1) | Invention | 62.6 | 0.3204 |
| Sample C (2) | Invention | 62.6 | 0.3387 |
| Sample C (3) | Invention | 62.6 | 0.3221 |
| Average | | | 0.3271 |

| | |
|---|---|
| Percent change in mass loss of Sample C vs. | −15% |
| Average of Sample A and Sample B | |

The graph of FIG. 1 shows the mass loss (mg) for Samples A and B based on the overall average of these two samples and the mass loss for Sample C. The results of the ASTM G65 dry sand abrasive test for the inventive material showing a 15% improvement compared to the conventional formulation are shown in FIG. 1.

The ASTM G75 (Abrasion Slurry Test) wear test was conducted to assess the resistance of Samples A, B and C to slurry abrasive wear. This type of wear is generally referred to as “erosion”. Four test samples (1), (2), (3) and (4) different from those used in the previous wear tests, were prepared from Samples A, B and C. Even though not indicated in Table 6, as stated herein above, the test samples (1), (2) and (3) of Sample A had a hardness of 60.3 HRC, the test samples (1), (2) and (3) of Sample B had a hardness of 64 HRC and the test samples (1), (2) and (3) of Sample C had a hardness of 62.6 HRC. The results are shown in Table 6, which indicate about a 50% reduction in mass loss for the inventive material of Sample C after exposure to abrasive slurry for four or more hours. This was calculated for each number of hours of exposure by taking the difference between the average mass loss of sample C less the mass loss of the average of Samples A and B and dividing this difference by the average mass loss for Samples A and B. For example, at four hours the percent change was calculated as follows:

% change=(44.7 mg−90.8 mg)/90.8 mg×100%=−50.8%

Repeating this calculation for 2 hours showed a −42.7% change and at 6 hours showed a −50.7% change.

TABLE 6
Results of the ASTM G75 Abrasion Slurry
Wear Test for Samples A, B and C

Mass Loss (mg) after the
stated hours of exposure

| Material | Products | 0 | 2 hrs. | 4 hrs. | 6 hrs. |
|---|---|---|---|---|---|
| Sample A(1) | Prior Art | 0.0 | 53.6 | 86.2 | 116.2 |
| Sample A(2) | Prior Art | 0.0 | 47.2 | 86.1 | 118.7 |
| Sample A(3) | Prior Art | 0.0 | 46.8 | 84.5 | 114.7 |
| Sample A(4) | Prior Art | 0.0 | 46.3 | 81.7 | 110.8 |
| Average | | 0.0 | 48.5 | 84.6 | 115.1 |
| Sample B(1) | Prior Art | 0.0 | 49.6 | 93.4 | 121.3 |
| Sample B(2) | Prior Art | 0.0 | 48.0 | 96.8 | 123.6 |
| Sample B(3) | Prior Art | 0.0 | 51.5 | 94.5 | 126.8 |
| Sample B(4) | Prior Art | 0.0 | 53.5 | 103.4 | 139.0 |
| Average | | 0.0 | 50.7 | 97.0 | 127.7 |

| | | | | |
|---|---|---|---|---|
| Overall Average of | 0.0 | 49.6 | 90.8 | 121.4 |
| Samples A and B | | | | |

| | | | | | |
|---|---|---|---|---|---|
| Sample C(1) | Invention | 0.0 | 28.5 | 41.6 | 54.3 |
| Sample C(2) | Invention | 0.0 | 30.8 | 44.5 | 57.1 |
| Sample C(3) | Invention | 0.0 | 27.7 | 53.0 | 76.2 |
| Sample C(4) | Invention | 0.0 | 26.5 | 39.5 | 51.8 |
| Average | | 0.0 | 28.4 | 44.7 | 59.9 |

| | |
|---|---|
| Percent change in mass loss | −50% |
| of Sample C vs. Samples A and B after | |
| four or more hours of exposure | |

The graph of FIG. 2 shows the mass loss (mg) of the conventional materials (prior art) based on the overall average of Samples A and B and the mass loss of the inventive material of Sample C resulted in about a 50% improvement for the inventive material after four or more hours of exposure. The results of the ASTM G75 slurry abrasion test for the inventive material showing a 50% improvement compared to the conventional formulations are shown in FIG. 2.

The Ce addition to the conventional formula for an iron-based hard facing composition did not change the hardness of the inventive material, but significantly increased the abrasion resistance according to two standard wear tests: 1) the ASTM G65 wear test which showed a 15% improvement in abrasion resistance of the inventive material compared to the conventional materials and 2) the ASTM G75 wear test which showed a 50% improvement in abrasion resistance of the inventive material compared to the conventional materials. In each of the wear tests, three to four test samples were used to ensure the consistency of the results. There was little variation in the results between samples.

The iron-based hard facing alloys with rare earth alloy additions of the present invention may also be used in conventional plasma coating processes as known to those skilled in the art.

Whereas particular embodiments of this invention have been described above for purposes of illustration, it will be evident to those skilled in the art that numerous variations of the details of the present invention may be made without departing from the invention.

What is claimed is:

1. A liner material for a backing steel cylinder, comprising:
an iron-based hard facing alloy comprising at least one a rare earth element.

2. The liner material of claim 1, wherein the at least one rare earth element comprises cerium.

3. The liner material of claim 1, wherein the at least one rare earth element is contained in the iron-based hard facing alloy in an amount less than about 2 weight percent based on the total weight of the alloy.

4. The liner material of claim 3, wherein the at least one rare earth element is contained in the iron-based hard facing alloy in an amount ranging from about 0.01 to about 0.50 weight percent based on the total weight of the alloy.

5. The liner material of claim 4, wherein the at least one rare earth element is contained in the iron-based hard facing alloy in an amount ranging from about 0.05 to about 0.20 weight percent based on the total weight of the alloy.

6. The liner material of claim 1, further comprising one or more elements comprising Cr, B, Si, C, P, S, Ni, Mn, Mo, Co, W, Ti and V.

7. A high pressure cylinder assembly, comprising:
a backing steel cylinder; and
a liner covering at least a portion of an inner surface of the backing steel cylinder, the liner comprising an iron-based hard facing alloy comprising at least one rare earth element.

8. The high pressure cylinder assembly of claim 7, wherein
at least one rare earth element is contained in the iron-based hard facing alloy in an amount less than about 2 weight percent based on the total weight of the alloy.

9. The high pressure cylinder assembly of claim 8, wherein
the at least one rare earth element is contained in the iron-based hard facing alloy in an amount ranging from about 0.01 to about 0.5 weight percent based on the total weight of the alloy.

10. The high pressure cylinder assembly of claim 9, wherein
the at least one rare earth element is contained in the iron-based hard facing alloy in an amount ranging from about 0.05 to about 0.2 weight percent based on the total weight of the alloy.

11. The high pressure cylinder assembly of claim 7, wherein the liner has a thickness ranging from about 0.03 inches (762 microns) to about 0.375 inches (9525 microns).

12. The high pressure cylinder assembly of claim 7, wherein the iron-based hard facing alloy further comprises one or more elements comprising Cr, B, Si, C, P, S, Ni, Mn, Mo, Co, W, Ti and V.

13. The high pressure cylinder assembly of claim 7, wherein the liner comprising the iron-based hard facing alloy has an average coefficient of friction less than that of a conventional iron-based hard facing alloy according to ASTM 77 adhesion/sliding wear test.

14. The high pressure cylinder assembly of claim 7, wherein the liner has at least about a 15% increase in abrasion resistance according to ASTM G65 dry sand abrasive test compared to a conventional iron-based hard facing alloy liner in a backing steel cylinder.

15. The high pressure cylinder assembly of claim 7, wherein the liner has at least about a 50% increase in abrasion resistance according to ASTM G75 compared to a conventional iron-based hard facing alloy liner in a backing steel cylinder.

16. A method of lining a high pressure cylinder assembly, comprising:
applying an iron-based hard facing alloy comprising at least one rare earth element onto the backing steel cylinder of the high pressure cylinder assembly.

17. The method of claim 16, wherein the at least one rare earth element is contained in the iron-based hard facing alloy in an amount less than 2 weight percent.

18. The method of claim 17, wherein the at least one rare earth element ranges from about 0.01 to about 0.5 weight percent based on the total weight of the iron-based hard facing alloy.

19. The method of claim 18, wherein the at least rare earth element ranges from about 0.05 to about 0.2 weight percent based on the total weight of the iron-based hard facing alloy.

20. The method of claim 16, wherein the at least one rare earth element comprises cerium.
